(19) United States
(12) Patent Application Publication
(10) Pub. No.: US 2002/0097119 A1
(43) Pub. Date: Jul. 25, 2002

(54) HERMETICALLY SEALED ELECTROMAGNETIC RELAY

(76) Inventors: Michael H. Molyneux, Santa Barbara, CA (US); Bernard V. Bush, Santa Barbara, CA (US); Brent J. Swartzentruber, Carpinteria, CA (US)

Correspondence Address: CHRISTIE, PARKER & HALE, LLP, 350 WEST COLORADO BOULEVARD, SUITE 500, PASADENA, CA, 91105, US

(21) Appl. No.: 09/773,997

(22) Filed: Jan. 31, 2001

Related U.S. Application Data
(63) Continuation-in-part of application No. 08/913,150, filed on Mar. 2, 1998.
(60) Provisional application No. 60/012,337, filed on Feb. 27, 1996.

(51) Int. Cl. H01H 1/66

(52) U.S. Cl. 335/202

(57) ABSTRACT

A sealed relay intended for high-voltage or high-power switching. The relay is enclosed in a hermetically sealed container comprising an open ended metal can sealed with an epoxy potting compound. The sealed relay is capable of long-term maintenance of either a high-vacuum or a pressurized insulating gas for the suppression of contact arcing during switching.

### CROSS REFERENCE TO RELATED APPLICATION

This application is a continuation in part of U.S. patent application Ser. No. 08/913,150 filed Mar. 2, 1998.

### BACKGROUND OF THE INVENTION

The present invention relates to the field of electromagnetic relays, and more particularly to high voltage, high current relays enclosed within hermetically sealed vacuum chambers.

Hermetically sealed electromagnetic relays are generally used for switching high electrical currents and/or high voltages. Such relays typically have fixed and movable contacts, and an actuating mechanism supported within a hermetically sealed chamber. High voltage, high current relays typically suffer from contact welding and short circuiting of the relay terminals through vapor deposition of metal across the relay housing. These problems are caused by arc formation between the moving contact the stationary contacts during hot switching operation. To suppress arc formation one of two approaches is typically used in a high power, high current relay. In one approach, the relay chamber is evacuated and sealed so that the fixed and movable contacts coact in a high-vacuum environment. In the other approach, the evacuated chamber is backfilled, and often pressurized, with an insulating gas having good arc-suppressing properties. A typical insulating gas is sulphur hexafluoride. The most important reason for making a high power relay that is hermetically sealed is that the sealed relay may be substantially smaller in size than an open frame relay of the same rating.

Prior art sealed relays typically house the relay components in a cylindrical or tubular metal base with a vacuum chamber either formed around or attached to base. Typically, the vacuum chambers consist of either a glass envelope fused to the metal base, or of a ceramic chamber brazed to the metal base. Both glass-to-metal joints and ceramic-to-metal joints have proven capable of providing a good hermetic seal.

Properly selected glass and ceramic materials provide the essential characteristics of low gas permeability, good insulating qualities, and low outgassing, that are required in high voltage, high current relay applications. However, both of the prior art approaches suffer from certain drawbacks. For example, glass envelopes are handmade by skilled artisans and are therefore expensive. In addition, glass envelopes are fragile and subject to breakage. Ceramic envelopes overcome some of the drawbacks of glass in that they are comparatively strong. However, ceramic envelopes are difficult to manufacture and are generally more expensive then their glass counterparts.

What is needed therefore is a low cost, durable, high voltage-high current relay enclosed within a housing which may be evacuated to a high vacuum and which may be backfilled and pressurized, if desired, with an inert or insulative gas. Ideally, such a relay would be comparatively simple to assemble and would utilize a plastic housing suitable for high volume production using well known injection molding techniques. In addition, the relay should be easily sealable through the use of an epoxy potting compound.

### SUMMARY OF THE INVENTION

The improved relay of the present invention overcomes the deficiencies of the prior art glass and ceramic enclosed relays by providing a relay enclosed within a novel vacuum-tight housing assembly. The relay is strong and durable and well suited to low cost, high volume production. The relay generally includes an open ended deep drawn can which encloses all of the electromagnetic components of the relay. The can forms part of a gas impermeable enclosure and also functions as part of the relay's magnetic circuit. The can is enclosed within an open ended plastic housing. The can is hermetically sealed by a layer of epoxy potting compound, which renders the sealed can impermeable to the inflow of air when subjected to high-vacuum, and to the outflow of insulating gas when backfilled and pressurized. The outer plastic housing serves to protect the can and to contain the epoxy sealant. Epoxy is the presently preferred sealing or potting material because it forms hermetic seals with metal and is substantially impermeable to inert and insulative gasses. Additionally, epoxies experience a slight shrinkage during curing which is a significant advantage over other compounds in that the shrinkage provides for a strong and reliable seal around metal components. In an alternative embodiment, the relay is assembled on a metal base to which the plastic housing is sealed. In another alternative embodiment, an envelope made entirely of epoxy is formed about the relay. Other features and advantages of the invention will become more apparent from the following detailed description of the invention, when taken in conjunction with the accompanying exemplary drawings.

### DESCRIPTION OF THE DRAWINGS

FIG. 1 is a perspective view of a sealed relay according to the present invention.

FIG. 2 is an enlarged sectional elevation of the relay before encapsulation, on line 2-2 of FIG. 5.

FIG. 3 is a reduced sectional elevation of the relay on line 3-3 of FIG. 5.

FIG. 4 is a top sectional view of the relay on line 4-4 of FIG. 2.

FIG. 5 is a top view of the assembly shown in FIG. 2.

FIG. 6 is an elevation of a cylindrical assembly which supports terminal pins and fixed/movable contacts of the relay.

FIG. 7 is a sectional elevation on line 7-7 of FIG. 6.

FIG. 8 is a bottom plan view on line 8-8 of FIG. 7.

FIG. 9 is an enlarged elevation of detail shown in the lower-right corners of FIGS. 2 and 3.

FIG. 10A and 10B are respectively a sectional side elevation and a top view of second embodiment of the invention using an open-frame relay in a plastic cup supported in an outer metal cup, the assembly being shown before encapsulation.

FIG. 11 shows the assembly of FIGS. 10A and B in a closed chamber having evacuation, pressurization and encapsulation-material valves.

FIG. 12 is a view similar to FIG. 11, and showing the relay assembly filled with cured encapsulation material.

FIG. 13 is a cross-sectional view of an improved hermetically sealed electromagnetic relay in accordance with the present invention.

FIG. 14 is top view of the relay shown in FIG. 13.

FIG. 15 is a side view of the relay shown in FIG. 13.

FIG. 16 is a schematic view of the relay depicted in FIG. 13, showing in particular the shadow feature of the relay which prevents metal deposits due to arcing from shorting the two stationary contacts.

### DETAILED DESCRIPTION OF THE PREFERRED EMBODIMENTS

For purposes of this invention disclosure, a hermetic seal means a seal which is sufficiently strong and impermeable to maintain for a long term a high vacuum of about 10−⁵ Torr to 10−⁹ Torr (760 Torr=one atmosphere), and a pressure of at least 1.5 atmospheres.

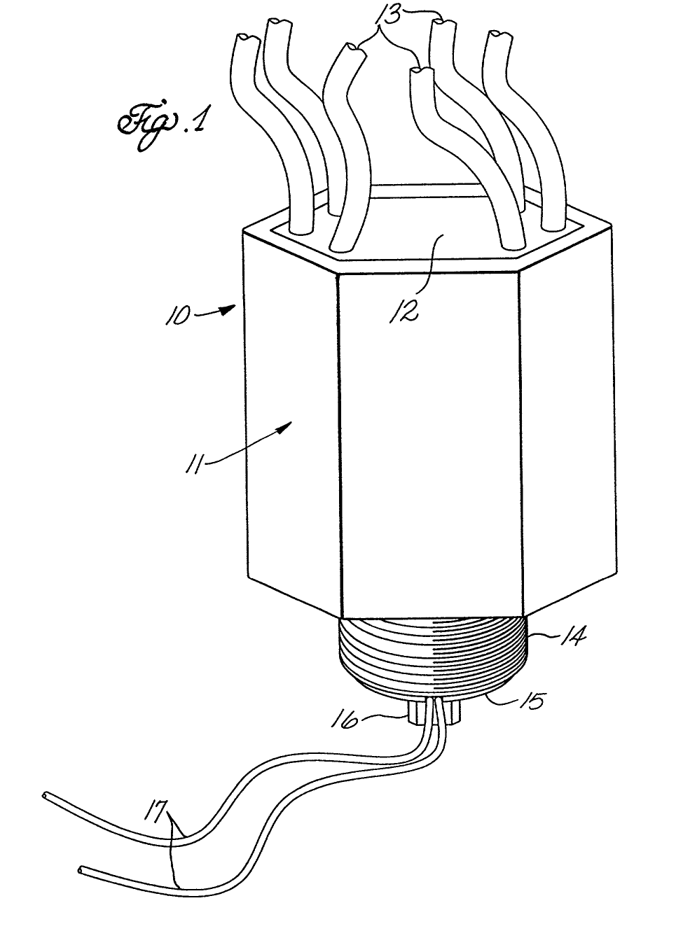

FIG. 1 shows a sealed relay 10 using a plastic and epoxy-sealed envelope to enclose the fixed and moving contacts of the relay. A primary external sidewall of the relay is formed by a plastic potting cup 11 which serves as a mold to hold epoxy material 12 poured into the cup and cured to provide a hermetic seal. Insulated electrical leads 13 extend through the epoxy material for connection of fixed and movable contacts to external circuitry. A threaded metal mounting base 14 extends through the underside of cup 11, and has a lower end closed by a metal cover plate 15 secured by a nut 16, and through which a pair of actuating-coil leads 17 extend for connection to external circuitry.

The concepts of the invention are useful in many different styles of hermetically sealed relays (whether of a high-vacuum type, or a back-filled or pressurized type), and will be described in the context of a double-pole double-throw relay using a conventional and typical electromagnetic actuator and fixed and movable contact assemblies. The invention is not limited to this specific configuration which is illustrated only by way of example, and is equally applicable to other types of sealed relays.

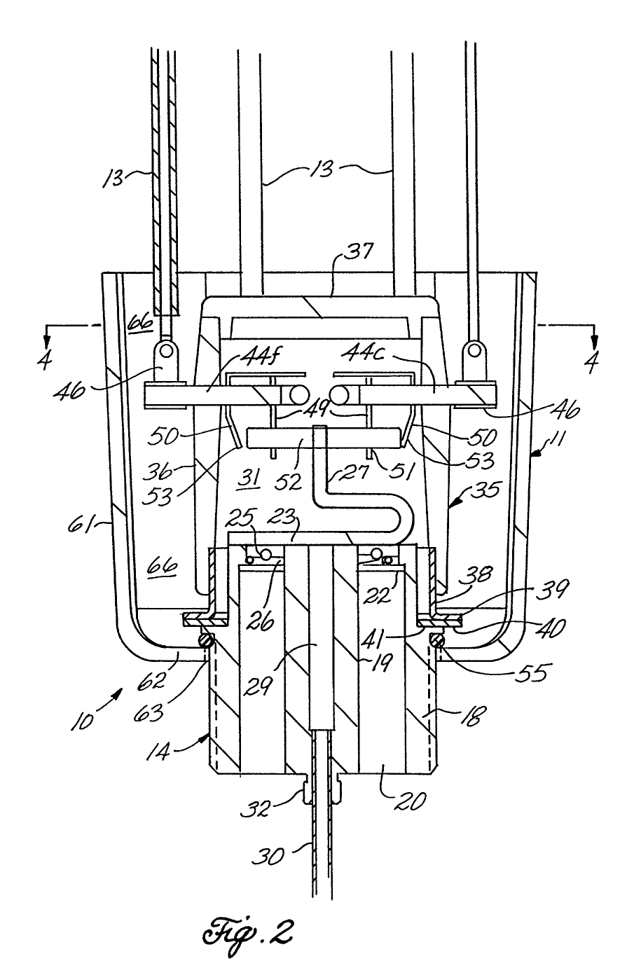

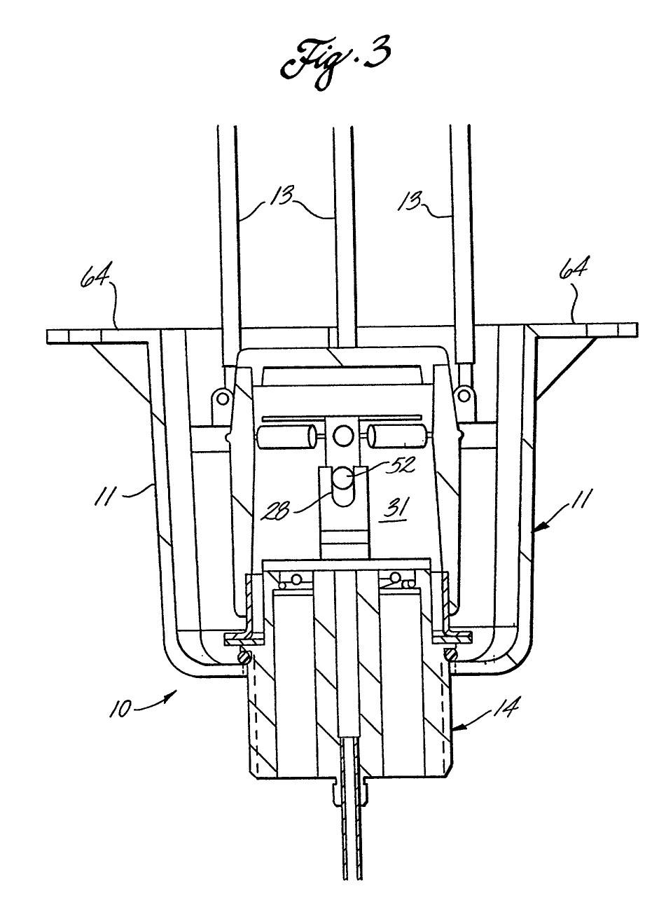

Referring to the sectional elevations of FIGS. 2 and 3, base 14 (made of a high-permeability magnetic-metal alloy such as C1018 iron) has a cylindrical sidewall 18, a central cylindrical pole piece 19, and an annular space 20 between the sidewall and pole piece into which is fitted a conventional actuating coil (not shown). The upper end of space 20 is closed by a washer-like disk 22 made of a non-magnetic material such as monel metal, and which is brazed to the sidewall and pole piece to provide a hermetic seal.

A movable armature 23 is pivotally mounted to the top of the base by a hinge (not shown). A coil spring 25 is seated in an annular space 26 between the upper ends of the sidewall and pole piece above disk 22, and urges the armature away from the pole piece when the relay is in a nonenergized condition. The armature has an upwardly extending actuating leg 27 with a slot 28 (FIG. 3) at its upper end. The pole piece has a central bore 29 extending to an evacuation tube 30 brazed and hermetically sealed to the pole piece, and through which a sealed chamber 31 of the relay can be pumped down to a high vacuum (and, if desired, backfilled to a pressure of say three atmospheres with an insulating gas such as sulphur hexafluoride). Tube 30 is thereafter pinched off and sealed where it extends through an externally threaded boss 32 which receives nut 16.

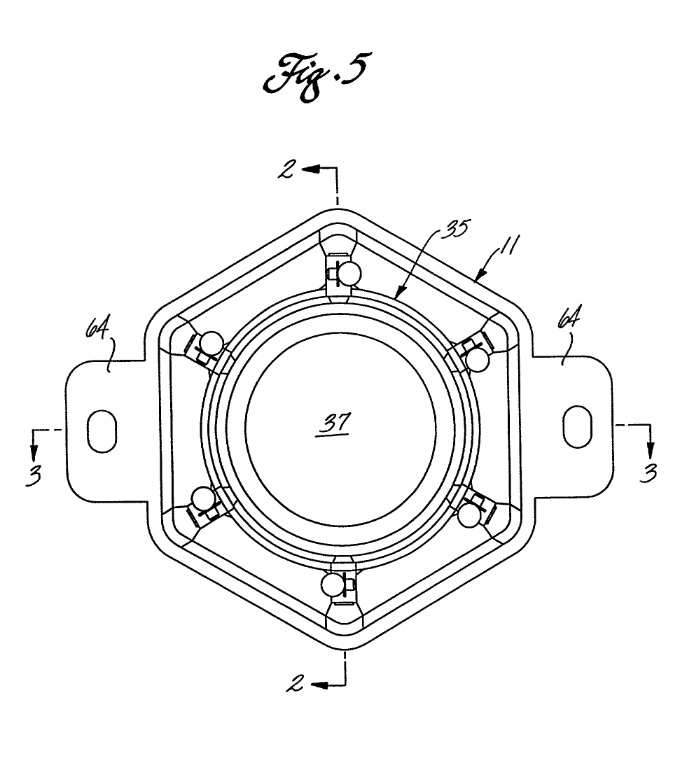

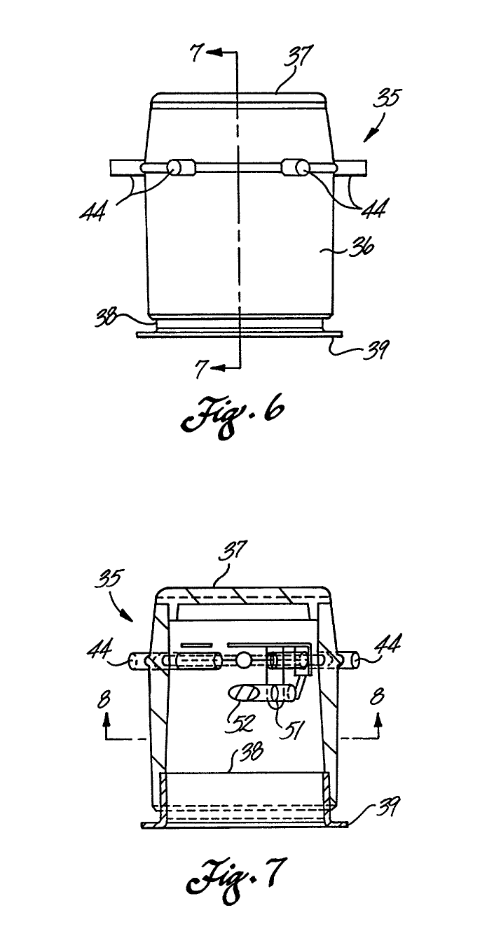

Sealed chamber 31 is enclosed by base 14 and a hollow assembly 35 as best seen in FIGS. 6-8. Assembly 35 includes a generally cylindrical plastic sidewall 36, an upper closure cap 37 press fitted into the upper end of the sidewall, and a metal ring 38 press fitted into the lower end of the sidewall and having at its lower end an outwardly extending flange 39 which is brazed to a metal disk 40 which is in turn brazed to a disk 41 brazed to an inwardly extending annular shoulder 41 in the outer surface of base 14 (FIGS. 2 and 9). These brazed junctions hermetically seal the joined components.

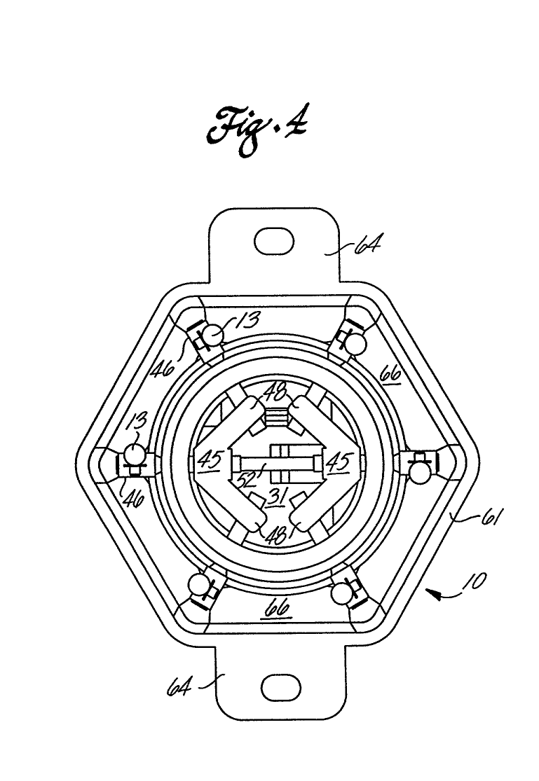

Six metal terminal pins 44a-f are radially spaced apart, and extend through sidewall 36 to form the six terminals of a DPDT switch. Pins 44 are fixtured in an injection mold in which plastic sidewall 36 is formed, and are thereby rigidly supported by the sidewall. Pins 44a-b and d-e form fixed contacts of the switch, and pins 44c and f are conductive posts on which a pair of movable contacts 45 (FIG. 4) are mounted. External leads 13 are secured to the pins by connectors 46 secured to the pins.

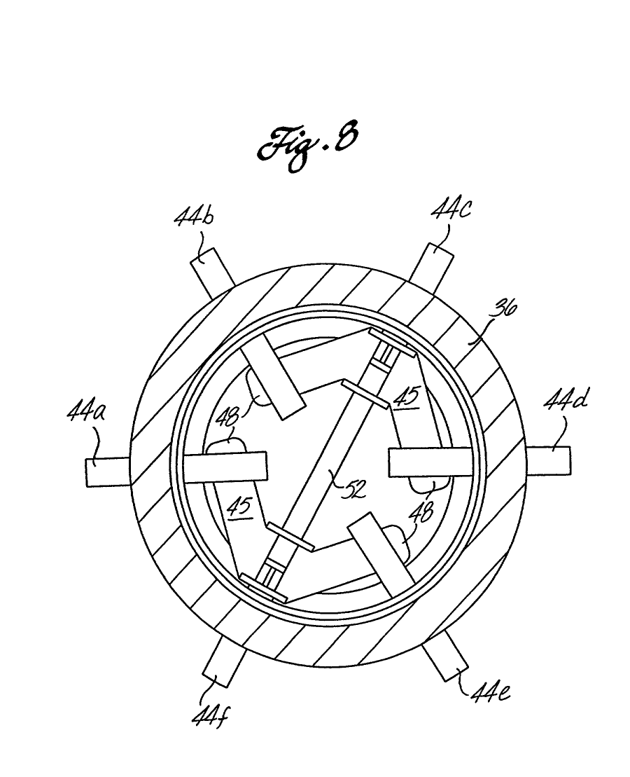

Each movable contact is Y-shaped in plan view (FIGS. 4 and 8) to define a pair of contact surfaces 48 which are urged against or away from one of the associated pair of fixed contacts in seesaw fashion when the relay is energized or deenergized. Each movable contact has a pair of downwardly extending inner and outer tabs 49 and 50 each having a hole at its upper end so the contact can be fitted over associated pin 44.

A lower hole 51 extends through each inner tab 49 to receive an insulated rod 52 which couples the movable contacts together. Rod 52 is fitted into slot 28 of armature leg 27 (FIG. 3), and is held captive between the movable contacts by a lower end 53 of each outer tab 50. This general style of fixed and movable contact assembly is conventional, and is described in greater detail in, for example, U.S. Pat. No. 3,604,870, the disclosure of which is incorporated herein by reference.

The relay is assembled by placing assembly 35 against base 14 with ring flange 39 against disk 40, and insulated rod 52 engaged in slot 28 of the armature leg. With cap 37 removed, proper alignment of the parts can now be checked by actuating the relay coil, and any necessary adjustments are made before welding ring flange 39 to disk 40. Cap 37 is then press fitted into sidewall 36, and an O-ring 55 is fitted into an annular groove 56 in the outer surface of base sidewall 18 beneath disk 40 (FIG. 9).

Open-top plastic (Nylon 6/6 is a presently preferred material) potting cup 11 has a hexagonal sidewall 61 and a bottom wall 62 having a central circular opening 63 which receives the threaded lower end of base 14 as shown in FIGS. 2 and 8. Optional mounting tabs 64 (shown in FIGS. 3-5) may be integrally molded with the potting cup if desired. The potting cup is tightened on base 14 to compress O-ring 55 by temporarily tightening a nut (not shown) on the externally threaded part of the base against the cup.

With the assembly fixtured in an upright position, external leads 13 are supported to extend vertically from pins 44, and uncured epoxy 12 is then poured into a space 66 between the exposed outer surfaces of assembly 35 and base 14, and the inner surface of the potting cup. The epoxy also covers the top of assembly 35, and fills the potting cup as shown in FIG. 1. After conventional curing of the epoxy, the relay is evacuated (and, if desired, backfilled) through tube 30 which is then sealed by cold-weld pinch off, and the relay coil and associated cover plate 15 are secured in place by nut 16.

The body of encapsulating epoxy 12 forms a hermetic seal around all of the components which define sealed chamber 31. More specifically, hermetic seals are formed at the epoxy-to-metal junctions of the epoxy with pins 44 where they emerge from sidewall 36, with connectors 46, with the exposed portions of ring 38, disk 40 and sidewall 18 of the base. O-ring 55 is not relied on for a hermetic seal, and is instead used only to prevent leakage of uncured epoxy during the pouring and curing cycles.

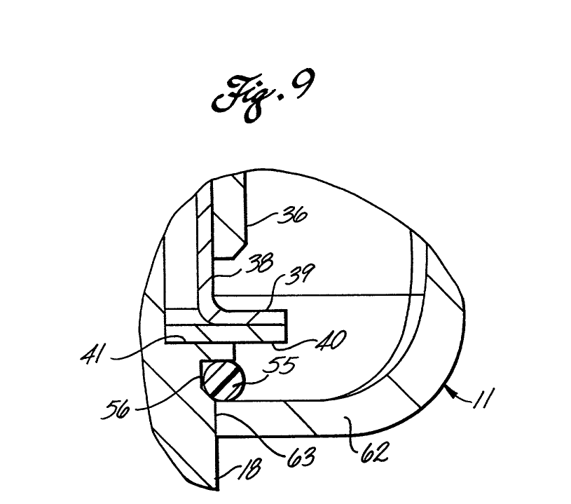

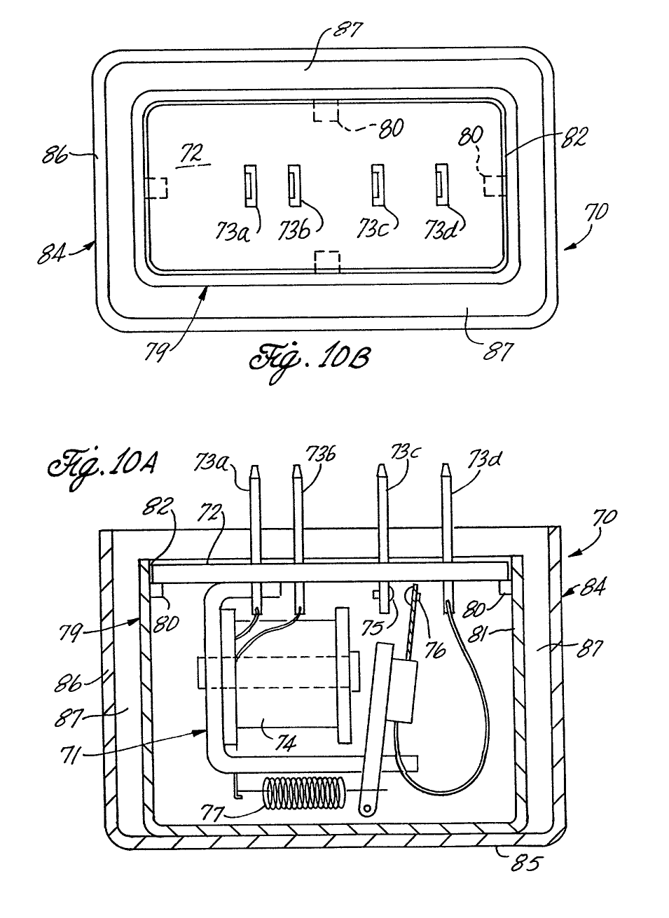

A second embodiment of a sealed relay according to the invention is shown in FIGS. 10-12, and this embodiment uses a simple and inexpensive open-frame relay in an open-top housing assembly which is evacuated, encapsulated and backfilled while positioned within a sealed chamber. This manufacturing method eliminates need for an evacuating and backfilling tubulation, and enables use of an inexpensive relay for high-voltage and high-power applications heretofore handled only by more expensive high-vacuum or pressurized units of known types as described in the introductory part of this specification.

Referring to FIGS. 10A and B, a relay assembly 70 is shown prior to encapsulation, and the assembly includes a conventional open-frame relay 71 (illustrated as a single-pole single-throw or SPST type, but other conventional contact configurations are equally useful) secured to and suspended from a generally rectangular header 72. Elongated metal terminal pins 73a-d extend through the header, and pins 73a and b are connected to a coil 74 of the relay electromagnetic actuator. Pin 73c supports a fixed contact 75, and pin 73d is connected to a movable contact 76 which is pulled against the fixed contact when the relay is energized. A coil spring 77 urges the movable contact into an open position in conventional fashion.

Relay 71 is positioned within an open-top plastic cup 79, with the underside of header 72 supported on short spaced-apart lugs 80 which extend inwardly from the inner perimeter of a sidewall 81 of cup 79 slightly below the top of the cup. The header does not make a snug press fit within the upper end of the cup, and there is instead an intentional narrow gap 82 of say 0.002-0.003 inch between the side edges of the header and the inner surface of sidewall 81.

Plastic cup 79 is in turn centrally fitted within an open-top metal cup 84 having a base 85 against which the plastic cup rests, and an upwardly extending sidewall 86. The plastic cup is smaller in external dimension than the interior of sidewall 86, creating a space or gap 87 between the plastic and metal cups. Sidewall 86 extends higher than the top of the plastic cup, and pins 73a-d in turn extend higher than the top of the metal cup. An acceptable alternative to metal cup 84 is a similarly shaped plastic cup having a separate metal plate resting on the cup bottom for bonding with encapsulation material.

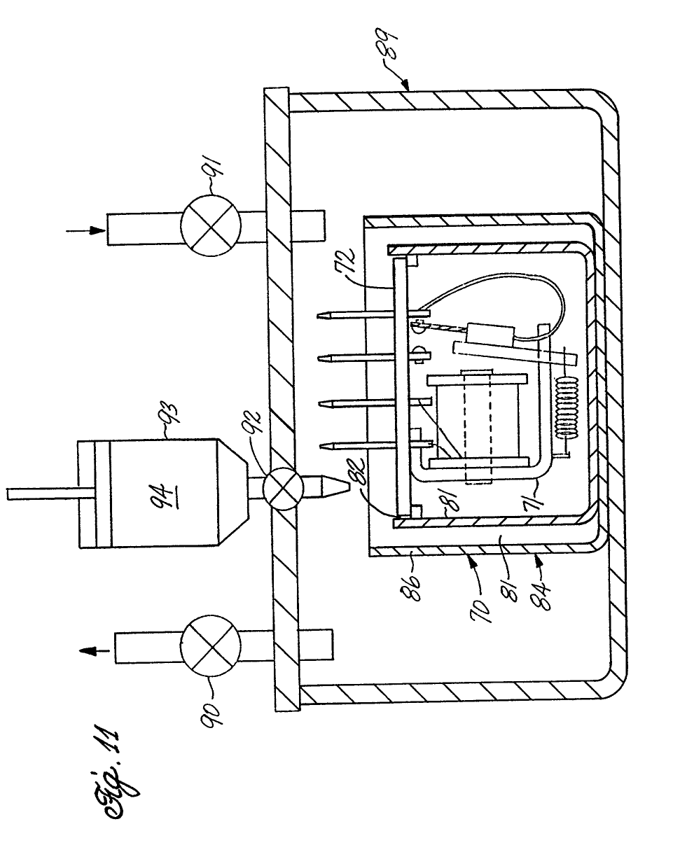

The thus-assembled components are next placed in a sealed chamber 89 as shown in FIG. 11. The chamber has an evacuation valve 90 connected to a high-vacuum pumping system (not shown) of a conventional type using mechanical and diffusion pumps. The chamber also has a pressurization valve 91 connected to a pressurized source (not shown) of an insulating gas such as SF₆. The chamber further has a third valve 92 positioned above cup 84, and connected to a piston-cylinder assembly 93 for holding and delivering a metered amount of uncured viscous, but fluid encapsulating material 94.

Evacuation valve 90 is then opened, and the high-vacuum pumping system actuated to withdraw air from the chamber interior to a vacuum which is preferably at least 10−² to 10−¹ Torr if the relay is to be backfilled. Ambient air is simultaneously withdrawn from relay assembly 70 through gap 82 between header 72 and sidewall 81. Valve 90 is closed when a desired vacuum is achieved.

Open-frame relays are unsuited for long-term vacuum operation due to outgassing of components such as the relay coil which will eventually contaminate and adversely affect a high-vacuum environment. This problem is eliminated by backfilling and pressurizing the chamber and as-yet-unsealed relay assembly with an insulating gas which is admitted by opening pressurization valve 91. The gas flows freely through gap 82 to fill and pressurize the interior of the relay assembly.

With the chamber interior stabilized in a high-pressure condition, valve 90 is closed, valve 92 is opened, and piston-cylinder assembly 93 actuated to deliver at a pressure exceeding that of the pressurized chamber a metered amount of fluid encapsulating material into metal cup 84 to completely fill gap 87 and cup 84 to a level just beneath the top of sidewall 86 as shown in FIG. 12. The encapsulating material is too viscous to pass through small gap 82, and the backfilled environment within the relay assembly remains undisturbed.

Preferably, chamber 89 is of a conventional type which includes a heater such as an induction heater, and heat is applied to the now-encapsulated relay assembly to cross link and cure the encapsulating material. With the chamber vented to atmosphere, the completed relay assembly is removed for testing and packaging. In production, many relay assemblies would be processed in a single loading of the chamber, and the methods of the invention can also be adapted for use in a continuous production line.

The optimum environment in which the relay contacts make and break is dependent upon the required performance of the relay. Vacuum (less than 10−⁵ Torr) is generally a good environment for high-voltage applications, but would not be chosen for applications where relay components in the vacuum environment might outgas. There are many gases that can be used to improve electrical performance of a relay. Sulfur hexafluoride (SF₆) is a good dielectric gas which at higher pressure will standoff significantly higher voltages than open air. A relay that will standoff 5 kilovolts in open air will standoff 40 kilovolts if it is pressurized with 10 atmospheres of SF₆. Another characteristic of SF₆ is that once ionized it becomes an excellent conductor. This makes it a good choice for relays that need to make into a load and keep consistent conduction of current while the load is being discharged. It is not a good gas, however, if that load needs to be interrupted, because the SF₆ will tend to continue conduction, and prevent the load from being interrupted.

There are several kinds of epoxy materials which bond satisfactorily with metal and, which are impermeable to prevent leakage of air into a vacuum relay, or loss of insulating gas in a pressurized relay. A presently preferred material is commercially available under the trademark Resinform RF-5407 (75% alumina filled) mixed 100:12 by weight with Resinform RF-24 hardener. Alternative epoxy materials should provide these characteristics:

| | |
|---|---|
| a. | Low gas permeability (less than 10−¹⁰ standard cubic centimeters of |
| | air per second). |
| b. | High dielectric strength (greater than 100 volts per mil). |
| c. | Low outgassing (to maintain a vacuum of 10−⁵ Torr or better). |
| d. | Good mechanical strength. |
| e. | Thermal expansion characteristics reasonably matched to those of the |
| | metal with which the epoxy forms a hermetic seal. |

To meet environmental standards typically required by military specifications and other standards, the hermetically sealed relays are often exposed to thermal shocks during tests, which may include exposure to extreme temperatures ranging, e.g., from −55 to +85 degrees C. When the electromagnetic components of the relay are completely encapsulated within epoxy for hermetic sealing, the sealing may crack during exposure to thermal shocks unless large amount epoxy is used. The hermetically sealed relay typically increases in size and weight due to the use of large amount of epoxy.

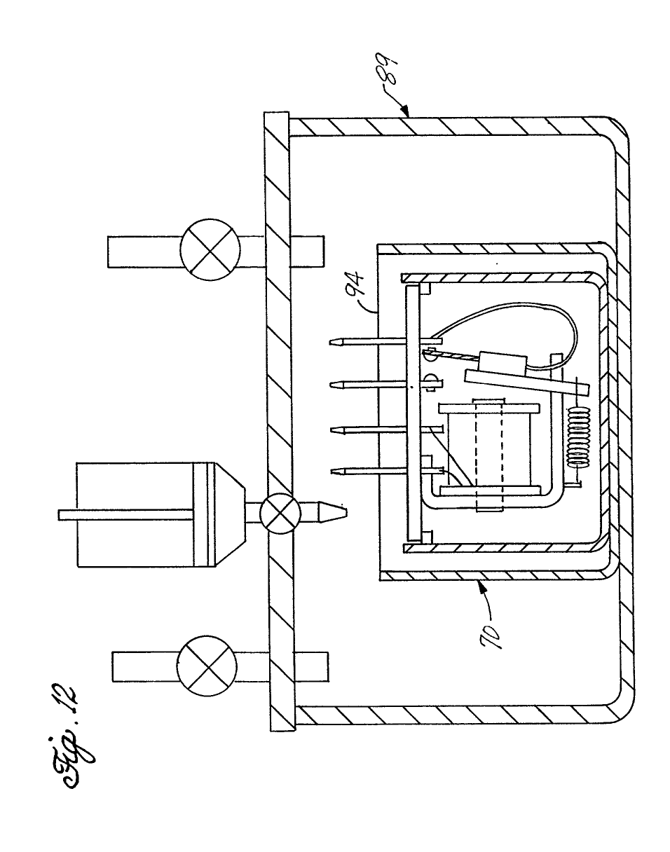

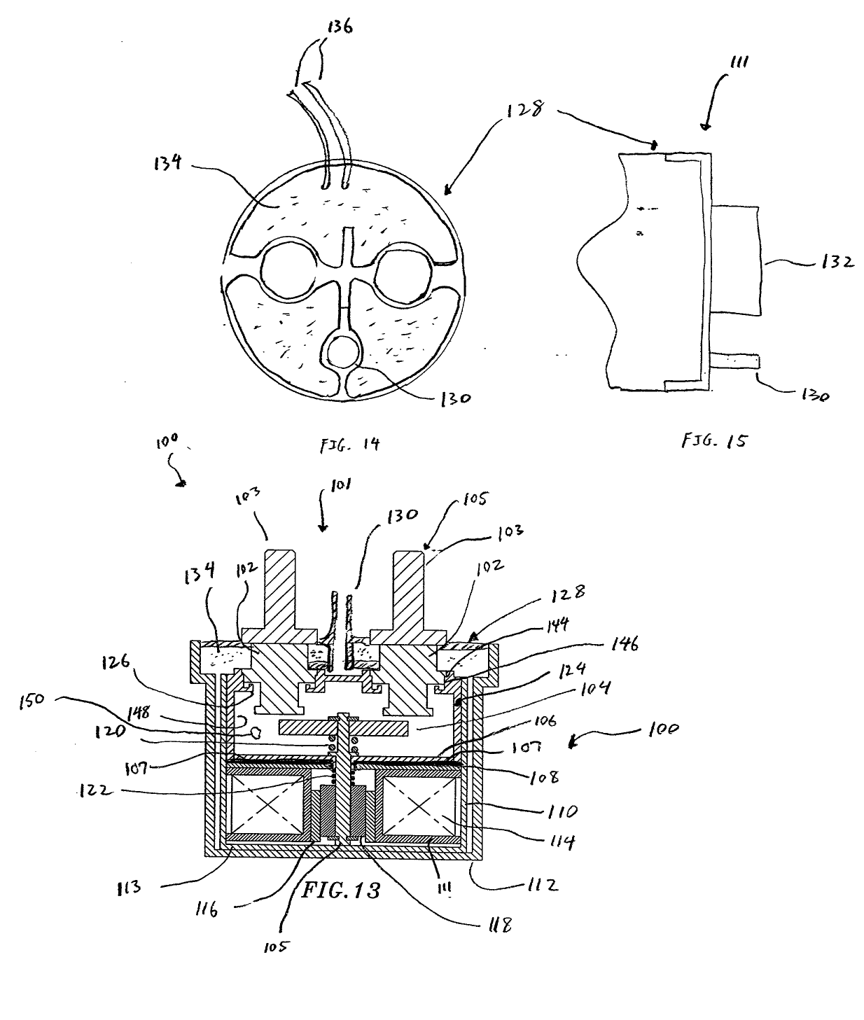

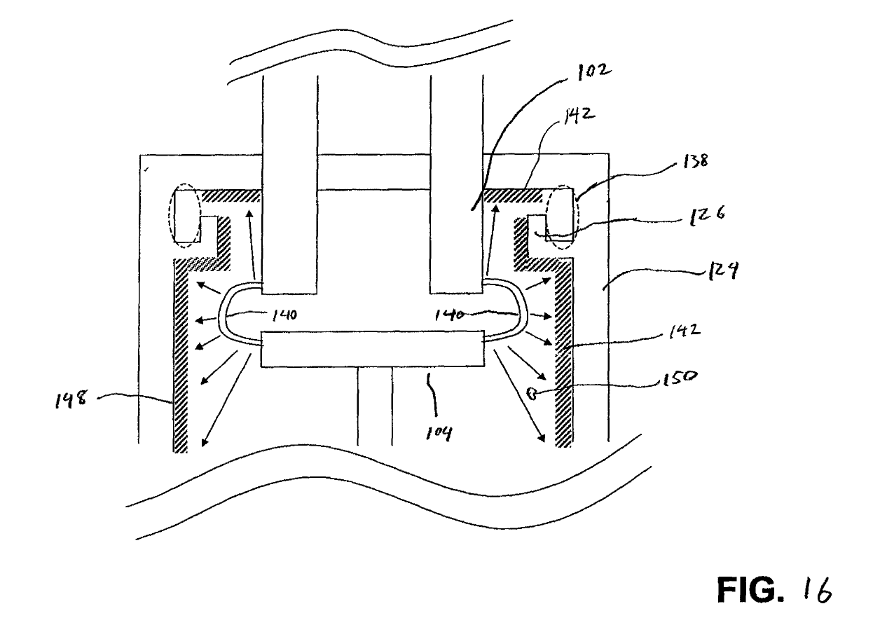

Referring now to FIGS. 13-15, an improved relay or contactor 100 in accordance with the present invention is depicted. Generally, the relay comprises a relay assembly 101 enclosed within a housing assembly 111, where the relay assembly is hermetically sealed within the housing assembly by a thin layer of epoxy potting compound 134.

The relay assembly 101 includes a pair of stationary contact assemblies 105 and a movable contact 104. Each stationary contact assembly comprises a lower stationary contact 102 and an upper terminal 103 attached to the contact 102. The contact assemblies are held in a fixed spaced relationship with respect to the movable contact by a plastic inner housing 124. The inner housing rests on a top core 108. The movable contact is pivotably attached to an insulated rod 105, which is attached to a movable core 118. The movable core is slidably received within, and forms part of a magnetic circuit with, an inner core 116. The inner core is disposed within an excitation coil 114 which is wound on a bobbin 111. The inner core effectively acts as a flux tube for concentrating magnetic flux generated by the coil. The magnetic circuit is completed by a deep drawn can 110 and the top core 108, where the coil is sandwiched between a bottom 113 of the can and the top core. A biasing spring 122 biases the movable contact away from the stationary contacts and biases the movable core below the centroid of the coil. When the coil is energized, the movable core slides upwardly making an electrical connection between the movable and the fixed contacts. A pressure spring 120 serves to ensure that the movable contact always makes a connection with both of the stationary contacts. The pressure spring is isolated from the top core by a plastic spacer 106.

As previously stated, the deep drawn can 110 is used to form part of the magnetic circuit of the relay 100. However, the can also functions as a sealing container for the electromagnetic components of the relay, i.e., all of the electromagnetic components are enclosed within the can, with the exception of a the stationary contact terminals 103, and a pair of coil leads 136, which extend upwardly from the can. Suitable materials for the can are all ferro-magnetic materials with sufficient ductility to be deep drawn, and which are substantially impermeable to air, inert gases, and insulative gasses. In the exemplary embodiment, the can is made from C1008 iron based alloy. Other alloys are also suitable.

With continued reference to FIG. 13, the inner housing 124 includes a plurality of interior walls 148 which along with the spacer 106 define a contact chamber 150. The housing also includes two recesses 146, where each recess has a shoulder 144 for receipt and support of one of the stationary contacts 102. Each recess further includes an L-shaped lip 126. The L-shaped lip encircles each stationary contact and defines a shadow area 138 (indicated by the dashed lines in FIG. 16) about each contact. The shadow area prevents possible short circuiting of the stationary contacts by vapor deposition of contact metal along the walls of the contact chamber.

The vapor deposition process is illustrated schematically in FIG. 16. During hot switching applications, an arc 140 tends to form between the stationary contacts 102 and the movable contact 104, as the movable contact moves towards the stationary contact. The formation of arcs between the contacts typically causes contact material to be burned off or vaporized from the contacts. The vaporized material subsequently is deposited along the walls of the contact chamber 150 and may over time form a conducting path or short circuit path 142 between the stationary contacts. The shadow area 138 tends to prevent or delay the formation of the short circuit path between the stationary contacts, and thereby extends the working life of the relay 100.

Arc formation between the stationary and movable contacts 102 and 104 also tends to generate a significant quantity of heat. For this reason the inner housing 124 should preferably be made from a heat resistant plastic material. In the exemplary embodiment, the inner housing is made from a 30% glass filled nylon material. Various other polymers such as polyamide, polyester, PET, and polyolefin materials are suitable and known in the art. To prevent product failure and potential safety hazard at high current interrupt (e.g., greater than 1500 A) due to arcing through the interface of inner housing 124 and spacer 106 and shorting to top core 108 and the coil 114, a dielectric membrane 107 is preferably disposed between spacer 106 and top core 108. The dielectric membrane 107, which may be Teflon or other suitable material, preferably has a high dielectric constant and withstands high temperature pinpoints to effectively prevent arcs from shorting out to top core 108.

Referring again to FIGS. 13-15, the housing assembly 111 of the relay 100 includes a plastic outer housing 112 and an upper closure 128. Disposed within the outer housing 112 is the can 110 which encloses all of the other components of the relay assembly 101. Extending upwardly from the can and through the upper closure are the stationary power terminals 103 and the electrical feed-through or coil leads 136. Sealing the can, housing, stationary contacts and the coil leads is the thin layer of epoxy potting compound 134. Given the relative depths of the can and the housing, the layer of epoxy needed to seal the relay may be as little as 0.100 inches deep. The outer housing may be made from a variety of polymer materials, including nylon, polyamide, polyester, PET, and polyolefin materials. Those skilled in the art will appreciate that the exact type of polymer chosen will depend upon the intended use of the relay.

The upper closure 128 of the housing assembly 111 may be equipped with an evacuation tube 130. The evacuation tube 130 extends below the level of the epoxy potting compound 134 and thereby allows the sealed relay 100 to be evacuated and/or backfilled with an inert or insulative gas. Preferably, the upper closure also includes an isolation bridge 132 for preventing arc formation between the exposed ends of the stationary contact terminals 103.

After assembly and curing of the potting compound 134, the integrity of the hermetic seal of the relay is preferably checked by pressurizing the relay with helium gas and checking for leaks. After leak checking, the relay 100 may optionally be evacuated and sealed to suppress arc formation within the relay. Typically, the relay will be evacuated to a vacuum of 10⁻⁵ Torr or less and preferably evacuated to about 10⁻⁹ or less. In order to further suppress arc formation, the relay may also be backfilled with an insulative gas to a pressure within the preferred range of about 20 to about 100 psi. There are many inert and insulative gases with varying properties known in the art. Nitrogen and sulphur hexafluoride are two examples. Once the improved sealed relay 100 has been evacuated and/or backfilled, the evacuation tube is pinched off and preferably capped. Methods for evacuating and backfilling relays are known to those skilled in the art.

The exemplary embodiment of the hermetically sealed relay 100 of the present invention is capable of conducting 200 A of current continuously at 1800V or carrying current interrupts of 2500 A at 320V. Those skilled in the art will understand that the relay 100 of the present invention may be sized to carry more or less current at a higher or lower voltage than that of the exemplary embodiment. The present invention relay is preferably suitable for use in any application where a low cost-high power direct current contactor is desired. The relay may be used, for example, in automotive applications, on industrial equipment and vehicles, and in telecommunications applications, among others.

Constructed in the general manner described and illustrated herein, the improved sealed relay of the present invention provides several advantages over prior art glass and ceramic enclosed relays. The improved relay provides a high power contactor enclosed in a deep drawn can and hermetically sealed in a low cost, high strength plastic housing. The relay may be evacuated to a vacuum within a range of 10⁻⁵ or less (preferably 10⁻⁹ or less) and may backfilled with an insulative or inert gas to a pressure preferably within a range of about 20 to about 100 psi. While only the presently preferred embodiment has been described in detail, as will be apparent to those skilled in the art, modifications and improvements may be made to the device disclosed herein without departing from the scope of the invention. Accordingly, it is not intended that the invention be limited except as by the appended claims.

What is claimed is:

1. A sealed electromagnetic relay comprising:
a can having an open end, wherein the can is substantially impermeable to gas;
an electromagnet disposed within the can, the electromagnet having an inner core disposed within an excitation coil, and a movable core being slidably movable within the inner core;
a plurality of stationary contacts;
a movable contact mechanically connected to the movable core of the electromagnet, the movable contact and core being biased to a normally open position by a biasing spring, wherein the movable contact is movable to a closed position contacting the stationary contacts to make an electrical connection in response to activation of the excitation coil;
an inner housing formed from an insulative material and having a plurality of interior walls defining a contact chamber, the housing supporting the stationary contacts and enclosing the movable contact;
a dielectric membrane disposed between at least a portion of the electromagnet and the contact chamber for preventing electrical contact during high current interrupt;
the inner housing, movable contact, and stationary contacts being disposed within the can, wherein electrical leads connected to the coil and terminals connected to the stationary contacts extend outwardly from the can;
a protective outer housing having an open end, wherein the housing encloses the can, the coil leads and stationary contact terminals extending outwardly from the housing; and
a layer of potting compound, wherein the potting compound hermetically seals the open end of can and is retained by the housing.

2. The sealed relay of claim 1, wherein the inner housing includes an L-shaped lip encircling each stationary contact, the lip defining a shadow area about each contact, wherein the shadow area prevents the creation of a short circuit path along the walls of the contact chamber caused by vapor deposition of contact metal generated during arcing between the stationary and the movable contacts.

3. The sealed relay of claim 1, wherein the can is made of a ferro-magnetic material.

4. The sealed relay of claim 2, wherein the can forms an outer core about the electromagnet.

5. The sealed relay of claim 1, wherein the electromagnet further includes a top core disposed on top of the excitation coil such that the coil is sandwiched between the top core and a bottom of the can.

6. The sealed relay of claim 1, wherein the movable contact includes a pressure spring for biasing the movable contact against each of the stationary contacts.

7. The sealed relay of claim 1, wherein the outer housing includes an evacuation tube which extends inwardly below the layer of potting compound.

8. The sealed relay of claim 7, wherein the relay is evacuated to a vacuum of 10⁻⁵ Torr or less.

9. The sealed relay of claim 7, wherein the relay is backfilled and pressurized with a gas at a pressure of about 20 psi to about 100 psi.

10. A sealed electromagnetic relay comprising:
a can having an open end, wherein the can is made of a ferro-magnetic material;
an electromagnet disposed within the can, the electromagnet having an inner core disposed within an excitation coil, and a movable core being slidably movable within the inner core, wherein the can forms an outer core about the electromagnet;
a plurality of stationary contacts;
a movable contact mechanically connected to the movable core of the electromagnet, the movable contact and core being biased to a normally open position by a biasing spring, wherein the movable contact is movable to a closed position contacting the stationary contacts to make an electrical connection in response to activation of the excitation coil;
an inner housing formed from an insulative material and having a plurality of interior walls defining a contact chamber, the housing supporting the stationary contacts and enclosing the movable contact;
a dielectric membrane disposed between at least a portion of the electromagnet and the contact chamber for preventing electrical contact during high current interrupt;
the inner housing, movable contact, and stationary contacts being disposed within the can, wherein electrical leads connected to the coil and terminals connected to the stationary contacts extend outwardly from the can;
a protective outer housing having an open end, wherein the housing encloses the can, the coil leads and stationary contact terminals extending outwardly from the housing; and
a layer of potting compound, wherein the potting compound hermetically seals the open end of can and is retained by the housing.

11. The sealed relay of claim 11, wherein the inner housing includes an L-shaped lip encircling each stationary contact, the lip defining a shadow area about each contact, wherein the shadow area prevents the creation of a short circuit path along the walls of the contact chamber caused by vapor deposition of contact metal generated during arcing between the stationary and the movable contacts.

12. The sealed relay of claim 10, wherein the can is made of a material substantially impermeable to inert gas.

13. The sealed relay of claim 10, wherein the electromagnet further includes a top core disposed on top of the excitation coil such that the coil is sandwiched between the top core and a bottom of the can.

14. The sealed relay of claim 10, wherein the movable contact includes a pressure spring for biasing the movable contact against each of the stationary contacts.

15. The sealed relay of claim 10, wherein the outer housing includes an evacuation tube which extends inwardly below the layer of potting compound.

16. The sealed relay of claim 15, wherein the relay is evacuated to a vacuum of 10⁻⁵ Torr or less.

17. The sealed relay of claim 15, wherein the relay is backfilled and pressurized with a gas at a pressure of about 20 psi to about 100 psi.
